(19) United States
(12) Patent Application Publication
(10) Pub. No.: US 2024/0345313 A1
(43) Pub. Date: Oct. 17, 2024

(54) METHOD AND SEMI-FINISHED PRODUCT FOR FABRICATING MULTICORE FIBERS

(71) Applicant: Heraeus Quarzglas GmbH & Co. KG, Hanau (DE)

(72) Inventor: Michael LORENZ, Bitterfeld-Wolfen (DE)

(21) Appl. No.: 18/293,089

(22) PCT Filed: Jul. 7, 2022
(86) PCT No.: PCT/EP2022/068887

§ 371 Date: Jan. 29, 2024

(30) Foreign Application Priority Data
Aug. 3, 2021 (EP) 21189393.8

(51) Int. Cl. G02B 6/02; G02B 6/38

(52) U.S. Cl. CPC G02B 6/02042; G02B 6/3885

(57) ABSTRACT

A method for fabricating a multicore fiber comprised of an elongate base body containing a glass cladding material and having at least two through-holes, inserting a core rod into the through-holes so as to form a component ensemble, drawing the component ensemble to form the multicore fiber, wherein the component ensemble is held from above by a holder made of glass, which is connected to the base body so as to form a welding contact surface. The fitting of the base body with core rods is not limited by the layout of the holder, and which in particular allows placement of all core rods from above even after the holder has been welded on, a holder with an elongate hollow part is used, having a hollow channel with an inner contour that is larger than a hole area circumference within which the through-holes lie at least 90% of their diameter.

### TECHNICAL BACKGROUND

The present invention relates to a method for fabricating a multicore fiber, comprising the following method steps:
(a) providing an elongate base body containing a glass cladding material and having a first end, a second end, a base body longitudinal axis, a base body lateral area, a radial base body cross-section, a base body outer diameter and at least two through-holes which extend through the base body along the base body longitudinal axis,
(b) introducing a core rod containing a glass core material into the at least two through-holes, thereby forming a component ensemble in which the core rods are distributed inside a circumference of the hole region around the base body longitudinal axis over the radial base body cross-section,
(c) drawing the component ensemble to form the multicore fiber or processing the component ensemble further to form a preform from which the multicore fiber is drawn, wherein the component ensemble is held by means of a holder made of glass, which is welded to the base body in the region of the first end to form a welding contact surface.

In addition, the invention relates to a semifinished product for fabricating a multicore fiber, comprising:
(i) a base body containing a glass cladding material and having a first end, a second end, a base body longitudinal axis, a base body lateral area, a radial base body cross-section, and a base body outer diameter,
(ii) at least two through-holes distributed over the base body cross-section for receiving core rods which each have a hole diameter, and which extend through the base body along the base body longitudinal axis, and
(iii) a holder made of glass, which is connected to the base body in the region of the first end to form a welding contact surface,

In multicore fibers, a plurality of optical core regions conducting light waves are integrated in the same fiber. The optical core regions are surrounded by sheath material and extend along the longitudinal axis of the fiber. This fiber design promises high capacity for signal transmission, because a plurality of signals are combined by spatial multiplexing methods and transmitted simultaneously in each of the core regions.

### PRIOR ART

For producing multicore fibers, the so-called “stack and draw method” is used, for example. Core rods and quartz glass cylinders of different diameters are stacked together in such a way that they have a relatively high packing density and a certain symmetry. The cylindrical components are inserted into a sheath tube and are spatially fixed therein. This ensemble is drawn into the multicore fiber or is elongated in advance into a preform from which the multicore fiber is then drawn.

The “stack and draw method” requires a great deal of calibration effort, easily resulting in problems with dimensional accuracy. Due to differences in the radial packing density, the elongate preform often has different radius values in the azimuthal direction, which have to be compensated for by circular grinding.

These disadvantages are avoided by a method described in JP 2018-052775 A and in JP 2014-201494 A for fabricating a multicore fiber. A base body is used in the form of a cylinder made of a sheath material, which is traversed by a plurality of through-holes which run in the direction of the longitudinal cylinder axis. One core rod containing a core material is inserted into each of the through-holes, which are produced, for example, by longitudinal perforation of the base body. A certain annular gap remains between the core rods and the inner walls of the base body due to the production process.

The ensemble of base body and core rods is drawn into the multicore fiber, or it is further processed into a secondary preform from which the multicore fiber is then drawn. In this elongation or drawing process, the annular gap collapses and the components of the ensemble are fused together. In order to avoid the inclusion of gas, a negative pressure is applied to the annular gap and the gap volume is evacuated. In order to evacuate the gap volume, a substantially cylindrical suction connection piece made of glass is welded to the upper end-face of the base body, and can simultaneously serve to hold the ensemble during the elongation process. It is also referred to below as the “holder”. The holder is fixed in the receptacle of a mounting piece of an elongation device, for example in the chuck of a drawing tower.

### TECHNICAL PROBLEM

To reduce production costs, as large-volume a base body as possible is processed, which is traversed by many through-holes, of which a few can extend far away from the longitudinal cylinder axis and can run close to the cylinder lateral area. The greater the volume of the base body, the greater its weight and the more stable the connection between the base body and the holder must be.

Due to the cylinder weight of, for example, up to 200 kg, the holder has to have a sufficiently large connection surface to the base body in order to avoid failure during handling. In addition to the mechanical stress due to the weight of the base body, the connection surface is also subject to a thermally induced tensile stress which can be slightly above 1 MPa in combination with the cylinder weight.

The stability of this connection can be increased by the use of thick-walled holders if the size of the connection surface between the base body and the holder is thereby increased. On the other hand, the holder diameter is often limited by a maximum receptacle width of the mounting piece, and the welded-on holder must also not be so thick-walled that it blocks the through-holes because an effective evacuation of the annular gap would then no longer be possible.

In JP 2018-052775 A, this problem is solved by an annular intermediate piece with a central opening being welded between the base body and the holder. The intermediate piece is fluidically connected to all through-holes via channels.

In JP 2014-201494 A, it is proposed to use a holder which is composed of a plurality of hollow-cylindrical dummy pieces over its length, the inner diameter and outer diameter of which decrease from the bottom to the top.

In the known solutions, the minimum inner diameter of the holder is smaller than the circumference in the base body cross-section within which the core rods and the openings of the through-holes lie. As a result, the holder completely or partially covers through-holes—in a projection onto the base body cross-section—so that the fitting of the base body with the core rods is not possible from above through the central holder opening. As a result, the fitting of the core rods must either take place from the opposite base body end, or must be carried out prior to the welding of the intermediate piece and holder.

Both method variants have disadvantages. The variant mentioned first makes handling more difficult, and in the second variant, the core rods inserted in the through-holes can be damaged by the heat input during subsequent welding of the holder. For example, the core rods can be deformed, in particular if they contain a glass which has a lower viscosity than the glass of the base body, which is usually the case. Or, sublimation products can precipitate on the core rods, which can lead to a deterioration of the light conduction of the multicore fiber.

Even if no core rod is yet inserted in the through-holes, the high temperature during the welding process can lead to a deformation, in particular a narrowing of the through-holes, which makes the subsequent fitting with the core rods more difficult. This applies in particular to through-holes which are in the vicinity of the weld seam or are even covered by the latter.

The object of the invention is therefore that of specifying a method for fabricating multicore fibers, in which the fitting of the base body with core rods is not limited by the layout of the holder, and which, in particular, enables fitting all core rods from above even after the holder is welded on.

In addition, the object of the invention is to provide a semifinished product suitable for carrying out the method.

### GENERAL DESCRIPTION OF THE INVENTION

With regard to the method, this object is achieved according to the invention, proceeding from the method mentioned at the outset, in that a holder having an elongate hollow part is used, which holder has a hollow channel with an inner contour which is larger than a circumference of the hole region within which the through-holes lie completely or with at least 90% of their hole diameter, and which has a radial outer dimension which is greater than the base body outer diameter.

The first end of the base body is also referred to below as the “upper end”, and the opposite, second end is also referred to as the “lower end”. The location adverbs denote the position of the respective ends during the fiber drawing process with a vertically oriented base body longitudinal axis. A first, upper base body end face is associated with the first, upper end.

The elongate base body is substantially cylindrical and has a circular cross-section. At the upper and/or at the lower end, it can have a thickening or a taper. The base body outer diameter is determined in the cylindrical longitudinal portion between the ends.

The hollow part is connected directly or indirectly to the base body via an intermediate piece (adapter part). The composite of the hollow part and base body is designed as a welded composite, forming a welding contact surface. The longitudinal axes of the hollow part and base body run coaxially. In the longitudinal section of the welded composite, when the base body longitudinal axis is oriented vertically, the welding contact surface runs, for example, vertically (parallel to the base body longitudinal axis), horizontally (perpendicular to the base body longitudinal axis), obliquely (inclined relative to the base body longitudinal axis), curved, or in a combination of these profiles in different portions.

The elongate hollow channel of the hollow part has, for example, a polygonal, round, oval—and preferably—a circular cross-section. In the longitudinal section, the hollow channel is cylindrical, or it is not cylindrical and has a constriction or an expansion in the longitudinal direction. The hollow channel inner geometry is designed such that the smallest cross-sectional contour lies outside of a circumference of the hole region in a projection onto the upper base body end face, within which the through-holes lie completely or with at least 90% of their hole diameter. In the simplest case, in the case of a hollow channel with a circular cross-section and a cylindrical longitudinal section, the hollow channel inner diameter is greater than the circumference of the hole region. If the through-hole diameter is covered to 10%, a round core rod, the diameter of which is 90% of the hole diameter or less, can be inserted through the remaining opening.

The through-holes each have a diameter that is large enough so that the corresponding core rod can be inserted. Conversely, the cross-section of the core rod accordingly has an outer contour which is smaller than the diameter of the through-hole. For example, the core rod has an outer diameter of a smaller diameter than the through-hole diameter. The greater the size difference between the core rod outer contour and the through-hole diameter, the easier it is to insert the core rod into the through-hole. A through-hole, the cross-section of which is partially covered by an already welded-on holder, can also be fitted with a core rod from the first, upper end of the base body, with the precondition that the non-covered cross-section of the through-hole encloses the core rod outer contour in cross-section. On the other hand, with increasing size difference between the through-hole diameter and the core rod outer contour, a reduced axial mechanical guidance of the core rod in the through-hole is accompanied by a deterioration in the quality of the light conduction in the multicore fiber. It has been shown that, when a through-hole is covered over up to 10% of its diameter by the welded-on holder, it is still possible to fit the first, upper end of the base body with a core rod, the cross-sectional dimensions of which are large enough to avoid the above-mentioned disadvantages. However, the overlap of the through-holes by the welded-on holder is preferably less than 10%, so that it is possible to fit core rods with a cross-sectional outer contour which deviates to a lesser extent from the diameter of the through-holes.

Particularly preferably, there is no overlap of the through-holes by the welded-on holder. In order to reliably prevent possible deformations of the through-hole during welding of the holder, the hollow part preferably has an inner diameter which is greater than the circumference of the hole region—for example, it is at least 2 mm greater, and particularly preferably at least 5 mm greater, than the circumference of the hole region.

The outer cross-section of the hollow part is, for example, polygonal, round, oval, and—in the simplest and preferred case—it is circular. In longitudinal section, the outer contour is cylindrical, for example, or it is not cylindrical and optionally has a constriction or an expansion in the longitudinal direction. The end of the hollow part facing the base body has a straight, oblique, curved or structured end face. Its maximum “radial outer dimension” is found as the projection onto the upper base body end face in the direction of the hollow part longitudinal axis. The maximum radial outer dimension of the hollow part limits the outer dimension of the welding contact surface (in the lateral direction); the radial outer dimension of the welding contact surface (in the lateral direction) can be smaller, but not greater than the maximum radial outer dimension of the hollow part.

Due to the fact that the maximum radial outer dimension of the end face of the hollow part is greater than the base body outer diameter, a welding contact surface can be formed which is greater than only the annular surface delimited by the base body outer diameter and the circumference of the hole region.

The drawing of the component ensemble of base body and core rods to form the multicore fiber, or the further processing to form a preform for the multicore fiber, comprises carrying out once or multiple times one or more of the following hot-forming processes: elongating, collapsing, collapsing and simultaneously elongating, collapsing additional sheath material, collapsing additional sheath material and subsequently elongating, collapsing additional sheath material and simultaneously elongating.

In order to hold the component ensemble in a drawing-, elongation- or collapsing device, the welded composite of the holder and the base body is produced in advance. In this case, the holder enables the stable holding of even comparatively large-volume and heavy component ensembles and/or component ensembles for which the circumference of the hole region is close to the base body outer diameter.

It has proven useful if, before the core rods are introduced into the through-holes, at least a portion of the welding contact surface, preferably the entire welding contact surface, is produced.

The core rods are introduced into the through-holes after complete or at least partial production of the welded composite of the holder and the base body. An impairment of the core rods by deposits of sublimate, and high temperatures during the welding process, are thus reliably prevented or reduced.

In a preferred method variant, at least a portion of the welding contact surface is generated on the base body lateral area. The hollow part engages exclusively or partially with the lateral area of the base body in this case. The upper end of the base body is essentially inserted into the hollow channel of the hollow part. This results in several advantages.
A contact surface (namely on the base body outer shell) of virtually any size is available for the welded connection between the hollow part and the base body. As a result of the large contact surface, particularly heavy, large-volume component ensembles can also be securely held.
Furthermore, because the welded connection is produced in the region of the lateral area through-holes, any core rods inserted therein are less influenced thermally than if the welded connection were produced on the upper base body end face. Deformations of the through-holes or of the core rods inserted therein, and impurities as a result of deposits, are thus prevented or reduced. This also applies in particular to through-holes and core rods which are arranged close to the edge of the base body.
In addition, through-holes in the region of the upper base body end face cannot be covered by the welding contact surface on the base body lateral area. They are freely accessible, so that core rods can also be inserted subsequently (after the welded composite is produced) from the upper base body end face. During the fiber drawing process or during further processing to form the preform, evacuation of the annular gap is not prevented or impaired.

It has also proven to be advantageous if the welding contact surface extends on the base body lateral area along an extension length in the direction of the base body longitudinal axis, wherein the extension length is in the range of 5 mm to 100 mm, and preferably at least 10 mm, and particularly preferably at least 20 mm.

The hollow part thereby encompasses the upper end of the base body, and the welding contact surface preferably is closed as it runs around the base body lateral area. In the case of extension lengths along the base body longitudinal axis of 5 mm or more, the welding contact surface does not only contribute to the weight deflection of the component ensemble, but, due to the hollow part being gripped, there is also a certain guidance for the component ensemble, which facilitates the coaxial alignment of the longitudinal axes of the base body and hollow part, and thus also the welding process. There is a further improvement if there are extension lengths of at least 10 mm, and particularly at least 20 mm. In the case of extension lengths of more than 100 mm, the loss of material in the holder and in the base body begins to erase the advantages due to the increased welding contact surface and the improved guidance and alignment of the component.

In particular, in order to further increase the strength of the welded connection and to simplify the assembly and alignment, it has proven to be advantageous if the welding contact surface comprises at least one circumferential step and/or at least one circumferential bevel over the extension length.

Viewed in longitudinal section, the welding contact surface optionally has a non-linear profile with a portion running parallel to the base body longitudinal axis and at least one step with a portion running perpendicular to the base body longitudinal axis, and/or at least one bevel with a portion running inclined relative to the base body longitudinal axis. This non-linear profile in longitudinal section leads to an increase in the welding contact surface. The inner contour of the holder and the outer contour of the base body are adapted to the non-linear profile of the welding contact surface in the manner of a lock and key.

In one embodiment, the welding contact surface extends exclusively on the base body lateral area. In a preferred method variant, however, the welding contact surface is generated both on the base body lateral area and on the first, upper base body end face.

An even larger welding contact surface is available as a result, so that it is possible to hold heavy component ensembles or preforms. The portion of the welding contact surface running on the base body longitudinal axis also facilitates the coaxial alignment of the longitudinal axes of the hollow part and the base body. Since the welded connection in the region of the base body lateral area removes a part of the weight of the component ensemble (or of the preform produced therefrom by fixing the core rods or by elongation), the available contacting surface on the upper base body end face does not have to be completely utilized. A certain safety margin from the through-holes or the core rods inserted therein can thus be easily maintained.

In a particularly preferred method variant, an adapter part is used which is connected to the base body in the region of the upper end, and which has a radial outer dimension which is greater than the base body outer diameter, wherein the adapter part is welded to the hollow-cylindrical hollow part.

The adapter part is connected to the lateral area and/or to the upper end face of the base body, for example by welding. It is, for example, in the form of an annular profile or in the form of a plate, and has a longitudinal or central axis which runs coaxially with the base body longitudinal axis.

Since it has a radial outer dimension which is greater than the base body outer diameter, it increases the contacting surface available for a welded connection with the hollow part. In this respect, the adapter part connected to the base body modifies the first, upper end of the base body in such a way that it allows a larger welding contact surface.

The direct contact between the hollow part and the adapter part can form the entire welding contact surface. However, a variant of the method is particularly preferred in which a portion of the welding contact surface is formed by direct contact between the hollow part and the adapter part, and a further portion of the welding contact surface is formed by direct contact between the hollow part and the base body. In this case, the connection between the hollow part and the base body is formed by a welding contact surface which is composed of a portion made by direct contact and a portion made by indirect contact (via the adapter part as an intermediate element) between the hollow part and the base body.

The maximum radial outer dimension of the hollow part is not necessarily greater than that of the adapter part. In the preferred case, the hollow part welded coaxially with the adapter part terminates radially flush with the adapter part, i.e., it does not protrude beyond or inside the adapter part.

For the connection between the adapter part and base body, the above-explained examples of the direct connection of hollow part and base body (by welding with the base body lateral area and/or with the upper base body end face) are suitable and preferred.

In a preferred method variant, an adapter part is connected to the base body, which is designed as an annular profile running around the lateral area of the base body. The shape and size of the inner lateral area of the annular profile on the one hand and the lateral area of the base body in the region of the upper end face on the other hand correspond to one another according to the key-lock principle. In the simplest case, the inner diameter of the profile ring corresponds to the outer diameter of the base body in this region.

In cross-section, the annular profile preferably has a polygonal shape, for example rectangular, trapezoidal, triangular or frustoconical shape, wherein it has a flat upper side facing the hollow part, which upper side is welded to the hollow part.

In a further preferred method variant, a substantially plate-shaped adapter part is connected to the upper end face of the base body, wherein the plate-shaped adapter part at least partially covers the circumference of the hole region, and wherein at least a portion of the through-holes extends through the adapter part.

The underside of the adapter part is connected to the upper end face of the base body, for example by welding. The hollow part is welded onto the upper side of the adapter part. The shape and dimensions of the upper side and the underside can be identical (cylindrical disk), or they can be different from one another. The adapter part preferably has the shape of a conical disk in which the radial dimensions of the upper side are greater than that of the underside. It can be designed as a solid plate or perforated plate, wherein the perforated plate has, for example, at least one central opening.

Since the adapter part, just like the hollow part, has a maximum radial outer dimension which is greater than the base body outer diameter, it increases the contacting surface available for the welded connection with the hollow part. In this procedure, the welding contact surface is generally produced solely by the direct connection between the hollow part and the adapter part, wherein optionally an exclusively indirect connection (via the adapter part as an intermediate element) is generated between the hollow part and the base body.

The substantially plate-shaped adapter part is provided with through-holes which run coaxially with all through-holes or to at least one of the through-holes of the base body. Preferably, the coaxial through-holes in the adapter part and in the base body are produced by drilling in one single work step. Optionally, the adapter part is connected to the upper base body end face before the drilling process, for example by welding.

With regard to the semifinished product, the above-mentioned technical object is achieved according to the invention, starting from a semifinished product of the type mentioned at the outset, in that the holder comprises an elongate hollow part which has a radial outer dimension which is greater than the base body outer diameter and which has an inner dimension which is greater than a circumference of the hole region within which the through-holes lie completely or with at least 90% of their hole diameter.

The semifinished product is present as a welded composite of holder and base body. After inserting core rods into the base body, a multicore fiber can be drawn therefrom, or it can be further processed into a preform for a multicore fiber.

The first end of the base body is also referred to here as the “upper end”, and the opposite, second end is also referred to as the “lower end”. A first, upper base body end face is associated with the first, upper end. The elongate base body is substantially cylindrical and has a circular cross-section.

At the upper and/or at the lower end, it can have a thickening or a taper. The base body outer diameter is determined in the cylindrical longitudinal portion between the ends.

The hollow part is connected directly or indirectly to the base body via an intermediate piece (adapter part). The composite of the hollow part and base body is designed as a welded composite, forming a welding contact surface. The longitudinal axes of the hollow part and base body run coaxially. In the longitudinal section of the welded composite, when the base body longitudinal axis is oriented vertically, the welding contact surface runs, for example, vertically (parallel to the base body longitudinal axis), horizontally (perpendicular to the base body longitudinal axis), obliquely (inclined relative to the base body longitudinal axis), curved, or in a combination of these profiles in different portions.

The elongate hollow channel of the hollow part has, for example, a polygonal, round, oval—and preferably—a circular cross-section. In the longitudinal section, the hollow channel is cylindrical, or it is not cylindrical and has a constriction or an expansion in the longitudinal direction. The hollow channel inner geometry is designed such that the smallest cross-sectional contour lies outside of a circumference of the hole region in a projection onto the upper base body end face, within which the through-holes preferably lie completely or with at least 90% of their hole diameter. The hole diameter is greater than the diameter of the core rod to be received in the through-hole, for example is 10% larger, so that a slight coverage of the through-hole does not prevent filling it with the core rod. In the preferred case, with a hollow channel with a circular cross-section and a cylindrical longitudinal section, the hollow channel inner diameter is greater than the circumference of the hole region. Preferably, there is no overlap of the through-holes by the welded-on holder. Optionally, the outer contour of the core rods can be adapted more precisely to the diameters of the through-holes, which is preferred, inter alia, due to more precise axial guidance of the core rod in the corresponding through-hole. In order to reliably prevent possible deformations of the through-hole during welding of the holder, the hollow part preferably has an inner diameter which is greater than the circumference of the hole region—for example, it is at least 2 mm greater, and particularly preferably at least 5 mm greater, than the circumference of the hole region.

Due to the fact that the projection of the hollow channel inner contour onto the upper base body end face lies completely outside or substantially outside of the circumference of the hole region, the hollow part does not cover the through-holes in the projection onto the base body end face, or at most covers a very small amount (more than 90% of the hole diameter is not covered), such that the through-holes are also accessible after the welding of the holder so that the fitting of the through-holes with core rods from the first, upper end of the base body is possible.

The outer cross-section of the hollow part is, for example, polygonal, round, oval, and—in the simplest and preferred case—it is circular. In longitudinal section, the outer contour is cylindrical, for example, or it is not cylindrical and optionally has a constriction or an expansion in the longitudinal direction. The end of the hollow part facing the base body has a straight, oblique, curved or structured end face. Its maximum “radial outer dimension” is found as the projection onto the upper base body end face in the direction of the hollow part longitudinal axis. The maximum radial outer dimension of the hollow part limits the outer dimension of the welding contact surface (in the lateral direction); the radial outer dimension of the welding contact surface (in the lateral direction) can be smaller, but not greater than the maximum radial outer dimension of the hollow part.

Due to the fact that the radial outer dimension of the end face of the hollow part is greater than the base body outer diameter, the welding contact surface can also be greater than the annular surface delimited by the base body outer diameter and circumference of the hole region.

The core rods are introduced into the through-holes of the semifinished product after complete, or at least partial, production of the welded composite consisting of the holder and the base body. An impairment of the core rods by deposits of sublimate, and high temperatures during the welding process, are thus reliably prevented or reduced. The holder also enables the stable retention of comparatively large-volume and heavy component ensembles and preforms.

In a particularly preferred embodiment, at least a portion of the welding contact surface runs on the base body lateral area. The hollow part engages exclusively or partially with the lateral area of the base body in this case. The upper end of the base body is essentially inserted into the hollow channel of the hollow part. This results in several advantages.
A contact surface (namely on the base body outer shell) of virtually any size is available for the welded connection between the hollow part and the base body. As a result of the large contact surface, particularly heavy, large-volume component ensembles and preforms can also be securely held.
Furthermore, because the welded connection is produced in the region of the lateral area through-holes, any core rods inserted therein are less influenced thermally than if the welded connection were produced on the upper base body end face. Deformations of the through-holes or of the core rods inserted therein, and impurities as a result of deposits, are thus prevented or reduced. This also applies in particular to through-holes and core rods which are arranged close to the edge of the base body.
In addition, through-holes in the region of the upper base body end face cannot be covered by the welding contact surface on the base body lateral area. They are freely accessible, so that core rods can also be inserted subsequently (after the welded composite is produced) from the upper base body end face. During the fiber drawing process or during further processing to form the preform, evacuation of the annular gap is not prevented or impaired.

Advantageous embodiments of the semifinished product according to the invention can be found in the dependent claims. To the extent that embodiments of the semifinished product specified in the dependent claims are reproduced in the methods mentioned in the dependent claims for the method according to the invention, reference is made to the above statements regarding the corresponding method claims for the supplementary explanation.

### DEFINITIONS AND MEASUREMENT METHODS

Individual terms of the above description are further defined below. The definitions are part of the description of the invention. For terms and measuring methods that are not specifically defined in the description, the interpretation according to the International Telecommunication Union (ITU) are relevant. In the event of an inconsistency between one of the following definitions and the rest of the description, the statements made in the description take precedence.

### Base Body

The base body consists of glass and it contains through-bores for receiving core rods. The glass adjacent to the through-bores has a refractive index which is lower than that of the glass of the core rods, having the highest refractive index. It consists, for example, of undoped quartz glass, or it contains at least one dopant decreasing the refractive index of the glass. Fluorine and boron are dopants which can lower the refractive index of quartz glass. The base body is elongate and has a substantially cylindrical shape with a nominal outer diameter. In the region of the end-face ends, deviations from the cylindrical shape and from the nominal outer diameter can be present.

### Core Rod

The core rods consist of glass and have a homogeneous or non-homogeneous refractive index profile in the radial direction. The glass having the highest refractive index is generally located in the central axis of the core rod. It consists, for example, of quartz glass, to which at least one dopant is added to increase the refractive index.

### Holder

The holder serves to hold a component ensemble or a preform in a device for drawing or elongation. It is one-piece, or is composed of a plurality of parts.

The first, upper end of the holder is fixed in the device, the other, opposite, lower end is welded directly or indirectly to the base body of the component ensemble or the preform via an intermediate element, such as, for example, via an adapter part. The end of the holder facing the base body comprises a hollow part with a central hollow channel. In the welded-on state, the longitudinal axes of the hollow channel and the base body run coaxially.

At least the end of the holder welded to the base body consists of glass, preferably of the same glass as the base body, for example of quartz glass.

### Component Ensemble/(Primary) Preform/Secondary Preform/Semifinished Product

The “component ensemble” comprises the base body with the core rods inserted into the through-holes. By fixing the core rods in the through-holes, for example by narrowing a base body end, a “preform” is obtained which is also referred to here as a “primary preform.” The component ensemble or the (primary) preform is elongated to form a “secondary preform”, or to form directly the multicore fiber. The welded composite of the holder and the base body is referred to as the “semifinished product”.

### Quartz Glass

Quartz glass is, for example, a melted product from naturally occurring SiO₂ raw material (natural quartz glass), or it is synthetically produced (synthetic quartz glass), or consists of mixtures of these quartz glass types. Synthetic, transparent quartz glass is obtained for example by flame hydrolysis or oxidation of synthetically produced silicon compounds, by polycondensation of organic silicon compounds according to what is referred to as the sol-gel method, or by hydrolysis and precipitation of inorganic silicon compounds in a liquid.

### Welding

When the components made of glass are referred to, welding is understood to mean that the components are fused to one another on a contact surface. The fusing takes place by heating the components to be welded at least in the region of the contact surface by means of a heating source, such as an oven, a burner, or a laser.

### Welding Contact Surface

The weight of the component ensemble or the weight of the preform is supported via the holder via the welding contact surface. The size of the welding contact surface is decisive for the strength of the welded composite consisting of the holder and the base body, or of the holder and preform.

The welding contact surface is the surface area of the welded connection between the holder on the one hand and the base body or the preform and/or an intermediate element connected to the base body on the other hand. The contacting surface available on the part of the holder determines and limits the size of the welding contact surface.

The welding contact surface is formed directly and/or indirectly between the holder and the base body. In a direct embodiment, the welding contact surface connects holder and base body directly to one another. In the indirect embodiment, the holder and base body are only in indirect contact with one another, i.e., by a mediating, intermediate element connected to the base body, and the welding contact surface connects the holder to the intermediate element.

### Adapter Part/Intermediate Element

The adapter part is a single piece, or is composed of a plurality of parts connected to one another. It is connected to the base body (for example by welding) and thereby arranged on the upper end face of the base body and/or laterally on its lateral area. As a result of the connection to the base body, the adapter part is suitable for enlarging the available contacting surface with the holder and thus the welding contact surface. At least a portion of the welding contact surface is thereby formed between the holder and the adapter part. The holder is indirectly connected to the base body via this part of the welding contact surface. In this respect, the adapter part also acts as an intermediate element between the base body and the holder.

### Position Indications: Top/Bottom

These indications relate to positions during the elongation process and/or during the fiber drawing process. “Bottom” denotes the position in the direction of the drawing process; “top” denotes the position counter to the direction of the drawing process.

### Cross-Section

The section taken perpendicular to the longitudinal direction/longitudinal axis.

### Longitudinal Section

A section taken parallel to the longitudinal direction/longitudinal axis.

### EXEMPLARY EMBODIMENT

The invention is explained in more detail below with reference to an exemplary embodiment and a drawing. In detail, in a schematic representation,

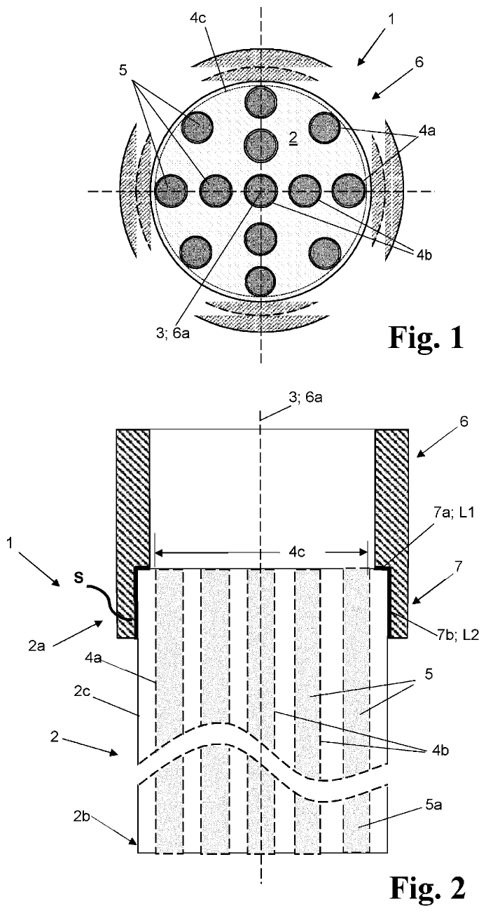

FIG. 1 is a cross-section of a (primary) preform for a multicore fiber in a plan view of the welded-on holder in a first embodiment,

FIG. 2 is the preform of FIG. 1 in a longitudinal section,

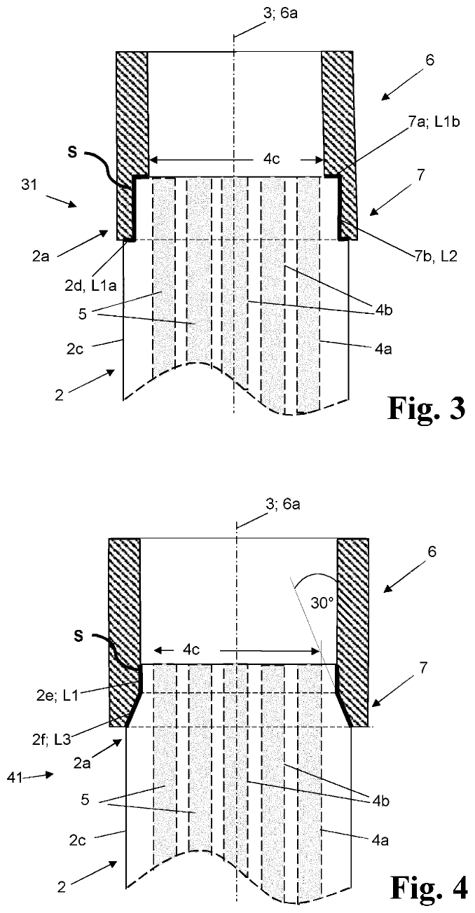

FIG. 3 is a longitudinal section of a second embodiment of a semifinished product in the form of a preform for multicore fibers,

FIG. 4 is a longitudinal section of a third embodiment of a semifinished product in the form of a preform for multicore fibers,

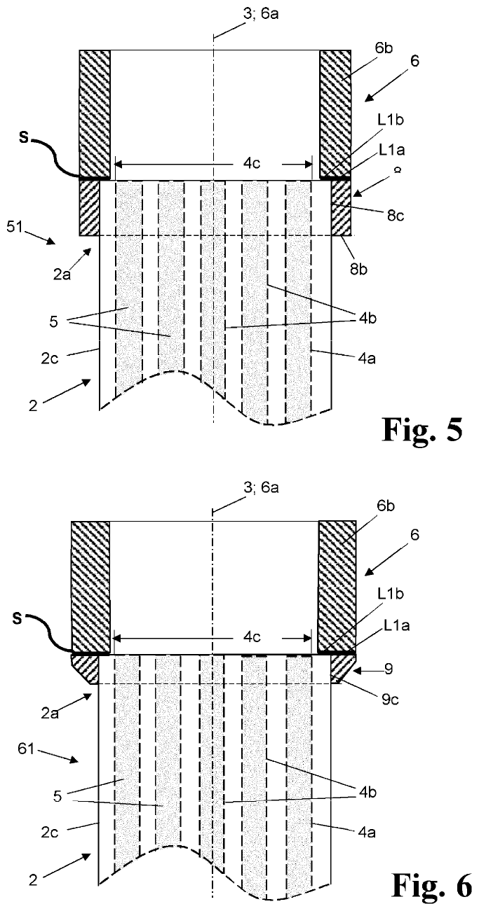

FIG. 5 is a longitudinal section of a fourth embodiment of a semifinished product in the form of a preform for multicore fibers,

FIG. 6 is a longitudinal section of a fifth embodiment of a semifinished product in the form of a preform for multicore fibers,

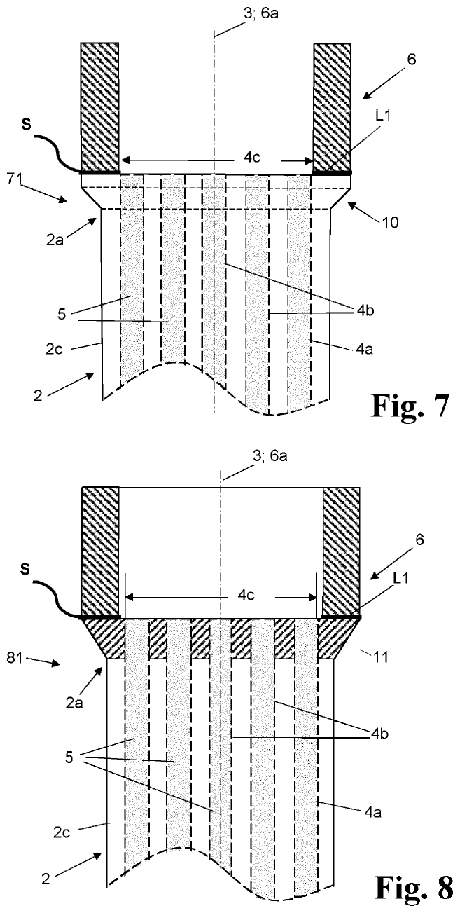

FIG. 7 is a longitudinal section of a sixth embodiment of a semifinished product in the form of a preform for multicore fibers,

FIG. 8 is a longitudinal section of a seventh embodiment of a semifinished product in the form of a preform for multicore fibers, and

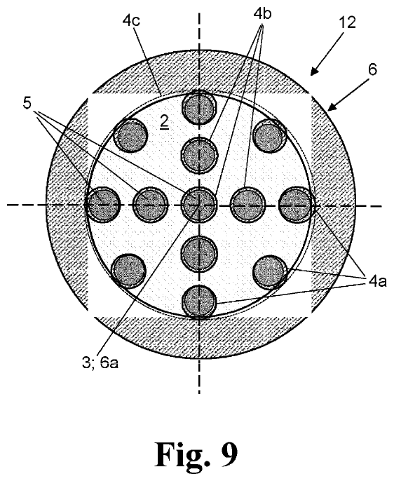

FIG. 9 is a cross-section of a preform for a multicore fiber in a plan view of the welded-on holder in a further embodiment.

FIG. 1 schematically shows a cross-section of a preform 1 for a multicore fiber which can be produced using the fabrication method of the invention. FIG. 2 shows the preform 1 in a longitudinal section.

The preform 1 comprises a sheath-material cylinder 2 made of synthetically produced, non-doped quartz glass with an upper end-face end 2a and a lower end-face end 2b, and with a cylinder lateral area 2c. The sheath-material cylinder 2 typically has a length in the range of 500 to 1500 mm and a nominal outer diameter in the range of 80 to 230 mm. In this embodiment and in all the following exemplary embodiments, the length is 1000 mm and the nominal outer diameter is 200 mm.

A plurality of through-bores 4a; 4b extends through the sheath-material cylinder 2 in the direction of the longitudinal cylinder axis 3. The through-bores 4a; 4b each serve to receive a core rod 55 with a substantially circular cross-section. In all embodiments, the core rods 55 consist of synthetically produced quartz glass which is doped with germanium in the conventional manner. The through-bores 4a; 4b are arranged in a symmetrical pattern, and the through-bores 4a are furthest away from the vertically oriented sheath-material cylinder longitudinal axis 3 and adjoin a circumference 4c of the hole region which runs coaxially with respect to the longitudinal axis 3, and the rest of the through-bores 4b are further removed from the circumference 4c of the hole region.

A hollow cylinder 6 of naturally occurring quartz crystal molten non-doped quartz glass is welded to the upper end face 2a of the sheath-material cylinder 2. The hollow cylinder 6 has an axis of gravity and central axis 6a which run coaxially with the sheath-material cylinder longitudinal axis 3.

FIG. 2 shows that the welding end 7 of the hollow cylinder 6 facing the upper end-face end 2a of the sheath-material cylinder 2 has an inner diameter expansion over a vertically oriented longitudinal portion 7b. The expanded inner diameter corresponds to the outer diameter of the sheath-material cylinder 2. The vertically oriented longitudinal portion 7b has a length L2 and rests against the lateral area of the sheath-material cylinder 2, and is welded thereto.

The inner circumferential step surface 7a is oriented horizontally and has a step depth L1. It rests on the upper end face 2a of the sheath-material cylinder 2, and is welded thereto. The size of the welding contact surface, which determines the strength of the welded connection, is made up of the welded longitudinal portion L1 and L2 and the corresponding radial dimensions.

These dimensions are summarized in Table 1 for the following embodiment 1 and for the following embodiments 2 to 7. The welding contact surface is highlighted by thick black lines S in the longitudinal sections shown in FIGS. 2 to 9.

The inner circumferential step surface 7a ends at an inner diameter of 180 mm. This diameter is greater than the diameter (170 mm) of the circumference 4c of the hole region. This means that the internal, circumferential step surface 7a does not cover any of the core rods 55. And it also does not cover any of the through-bores 4a; 4b. The diameter of the through-bores is typically in the range of 5 mm to 50 mm, and is 30 mm in this embodiment and in all the exemplary embodiments described below.

The production of the preform 1 according to FIGS. 1 and 2 is explained in more detail below:

A cylinder of non-doped, synthetically produced quartz glass having a length of 1000 mm is produced, and set by circular grinding to a nominal outer diameter of 200 mm. Through-bores 4a, 4b with a diameter of 30 mm are generated by mechanical drilling in the direction of the longitudinal axis 3. The through-bores 4a, which are remote from the longitudinal axis 3, lie within the circle 4c with a diameter of 170 mm.

Thereafter, the internally stepped welding end 7 of the hollow cylinder 6 of non-doped, synthetically produced quartz glass is contacted with and welded to the upper end face and to the lateral area of the sheath-material cylinder 2. Welding takes place by heating the welding end 7 by means of a burner flame. This produces a vertically oriented welding surface running around the cylinder lateral area 2 with the width L2, and an annular welding surface running on the end face with the width L1.

Core rods 55 made of Ge-doped quartz glass with a length of about 1000 mm and an outer diameter of about 28 mm are produced. Known techniques are suitable for this purpose, such as, for example, VAD method (Vapor Phase Axial Deposition), OVD (Outside Vapor Deposition) or MCVD (Modified Chemical Vapor Deposition) processes.

The core rods 5 are inserted into the through-bores 4a; 4b. The insertion into the through-bores 4a; 4b can take place both from below and from above, since the welded-on hollow cylinder 6 does not cover the through-bores 4a; 4b and because the through-bores 4a; 4b have not been deformed by welding the hollow cylinder 6. The core rods 55 are preferably inserted into the through-bores 4a; 4b from above.

The lower end of the sheath-material cylinder 2 fitted with the core rods 5 is then heated so that the annular gaps around the core rods 5 collapse. The component ensemble of sheath-material cylinder 2 and core rods 5 fixed in this way forms the primary preform 1, which is then elongated to form a secondary preform. In this case, the preform 1 is held in an elongation device by means of the hollow cylinder 6 with a vertical orientation of the longitudinal axis 3, and at the same time a negative pressure is applied to the hollow cylinder 6. The secondary preform produced in this way is finally drawn in a conventional manner into a multicore fiber in a drawing device, wherein the secondary preform is likewise held by means of the hollow cylinder 6.

In the preferred approach described above, the core rods 5 are inserted after the welding of the sheath-material cylinder 2 to the hollow cylinder 6. In another, less preferred approach, the core rods 5 are inserted into the through-bores 4a; 4b, and only thereafter are the sheath-material cylinder 2 and the hollow cylinder 6 welded to one another.

Where the same reference numbers as in FIGS. 1 and 2 are used in FIGS. 3 to 8, identical or equivalent components and components are thus designated as explained above with reference to the description of the first embodiment of the preform 1 and the fabrication thereof. In all embodiments of the preform, the outer diameter of the hollow cylinder is greater than that of the sheath-material cylinder 2 and its inner diameter is greater than the circumference 4c of the hole region.

TABLE 1
(all length specifications in mm)

| | Exemplary embodiment | | | | | | |
|---|---|---|---|---|---|---|---|
| | 1 (FIG. 2) | 2 (FIG. 3) | 3 (FIG. 4) | 4 (FIG. 5) | 5 (FIG. 6) | 6 (FIG. 7) | 7 (FIG. 8) |
| MM cylinder | | | | | | | |
| Material | Synthetic | Synthetic | Synthetic | Synthetic | Synthetic | Synthetic | Synthetic |
| | quartz glass | quartz glass | quartz glass | quartz glass | quartz glass | quartz glass | quartz glass |
| Mold | cylindrical | predominantly | predominantly | cylindrical | cylindrical | predominantly | cylindrical |
| | | cylindrical | cylindrical | | | cylindrical | |
| Maximum AD | 200 | 200 | 200 | 200 | 200 | 150 | 200 |
| Minimum AD | 200 | 190 | 190 | 200 | 200 | 130 | 200 |
| Nominal OD | 200 | 200 | 200 | 200 | 200 | 130 | 200 |
| Circumference of | 170 | 170 | 170 | 170 | 170 | 120 | 170 |
| the hole region | | | | | | | |
| Holder | | | | | | | |
| (hollow part) | | | | | | | |
| Material | Natural | Natural | Natural | Natural | Natural | Natural | Natural |
| | quartz glass | quartz glass | quartz glass | quartz glass | quartz glass | quartz glass | quartz glass |
| Mold | predominantly | predominantly | predominantly | cylindrical | cylindrical | cylindrical | cylindrical |
| | cylindrical | cylindrical | cylindrical | | | | |
| AD | 220 | 210 | 220 | 220 | 220 | 150 | 220 |
| Minimum ID | 180 | 180 | 190 | 180 | 176 | 122 | 180 |
| Maximum ID | 200 | 190 | 200 | 180 | 176 | 122 | 180 |
| Adapter part | none | none | none | | | none | |
| Material | | | | Synthetic | Synthetic | | Natural |
| | | | | quartz glass | quartz glass | | quartz glass |
| Mold | | | | Polygonal | Polygonal | | Cone disk |
| | | | | annular | annular | | (truncated |
| | | | | profile | profile | | cone) |
| AD | | | | 220 | 220 | | 220 |
| ID | | | | 200 | 200 | | |
| Height | | | | 25 | 10 | | 25 |
| Welding contact | | | | | | | |
| surface S | | | | | | | |
| Horizontal | approx. | approx. | | 100%/20 | 100%/22 | 100%/14 | 100%/20 |
| proportion/length | 16%/5 | 24%/8 | | | | | |
| L1 | | | | | | | |
| Vertical | approx. | approx. | approx. | | | | |
| proportion/length | 84%/25 | 76%/25 | 60%/15 | | | | |
| L2 | | | | | | | |
| Inclined | | | approx. | | | | |
| proportion/length | | | 40%/10 | | | | |
| L3 | | | | | | | |
| L1 + L2 + L3 | 30 | 33 | 25 | 20 | 22 | 14 | 20 |
| Total surface | 18,760 | 20,520 | 15,075 | 12,560 | 13,680 | 5979 | 12,560 |
| area [mm²] | | | | | | | |
| Δ Reference (%) | +180 | +235 | +172 | +144 | +157 | +305 | +144 |

### LEGEND

MM cylinder: sheath-material cylinder
ID: inner diameter
AD: outer diameter
“Cylindrical” shape: continuously cylindrical
“Predominantly cylindrical” shape: in the region of the first end there is a deviation from the cylindrical shape
Circumference of the hole region: the diameter of the circle within which the through-bores lie with 100%, or at least 90%, of their diameter
Length L1: total length of the (horizontal) longitudinal portion of the welding contact surface running perpendicular to the longitudinal axis (on one side of the longitudinal section through the hollow part wall)
Length L2: total length of the (vertical) longitudinal portion of the welding contact surface running parallel to the longitudinal axis (on one side of the longitudinal section through the hollow part wall)
Length L3: total length of the non-horizontal and non-vertically extending longitudinal portions of the welding contact surface (on one side of the longitudinal section through the hollow part wall)
Proportion: surface area proportion of the relevant longitudinal portion relative to the total area of the welding contact surface
L1+L2+L3: total length of the welding contact surface (on one side of the longitudinal section through the hollow part wall)
Δ Reference (%): difference between the total surface area relative to the surface area of the reference welding contact surface (annular surface between the nominal sheath-material cylinder outer diameter and the circumference of the hole region)

In the last row of Table 1, the difference in the total surface area of the welding contact surface is indicated in percent, based on the surface area of a reference welding contact surface which is defined as an annular surface between the outer diameter of the sheath-material cylinder and the circumference of the hole region (without overlapping the through-bores). It follows from this that in all embodiments, the welding contact surface is greater than the welding contact surface of the corresponding reference example.

FIG. 3 shows an embodiment of the preform 31 which, in contrast to FIG. 2, has an upper end face 2a of the sheath-material cylinder 2 which is cut in steps. The rectangular step 2d of the stepped profile thus produced has a depth L1a.

The welding end 7 of the hollow cylinder 6 has an inner diameter expansion over a vertically oriented longitudinal portion 7b. The expanded inner diameter corresponds to the outer diameter of the sheath-material cylinder 2 in the region of the rectangular step 2d. The vertically oriented longitudinal portion 7b has a length L2, and rests against the lateral area of the sheath-material cylinder 2 in the region of the rectangular step 2d, and is welded thereto.

The welding end 7 of the hollow cylinder 6 is welded to the rectangular step 2d over a length L1a, and to the upper end face of the sheath-material cylinder over a length L1b which corresponds to the inner diameter expansion of the hollow cylinder 2. A particularly stable welded connection is made possible in this way, and an additional guidance of the hollow cylinder 6 results. The sum of the lengths L1a and L1b results in the total proportion L1 of the welding contact surface S with a horizontal orientation.

In contrast to FIG. 3, in the embodiment of the preform 41 of FIG. 4, the upper end-face end 2a of the sheath-material cylinder 2 is cut in two steps. The cut comprises a cylindrical surface 2e running vertically from the top to the bottom with a length L2, which opens into a downwardly widening truncated cone (shown in cross-section as a cone section 2f) with a shell line length L3. The cone portion 2f forms, with the longitudinal axis 3a, a cone angle of 30 degrees, and extends up to the cylinder lateral area 2c. The sheath-material cylinder 2 and the hollow cylinder 6 are thus welded to one another over the inclined shell line length L3 and over the length L2 with a vertical orientation. The sum of the lengths L2 and L3 indicates the welding contact surface S.

In the embodiment of the preform 51 of FIG. 5, an adapter part is provided in addition to the hollow cylinder 6. The latter consists of a circumferential quartz glass ring 8 which is rectangular in cross-section and whose inner diameter corresponds to the outer diameter of the sheath-material cylinder 2. The adapter part (quartz glass ring 8) serves as a flange-like expansion of the outer diameter of the sheath-material cylinder 6. It is first welded with its inner lateral area 8c to the cylinder lateral area 2c of the sheath-material cylinder 2, such that the central axis of the quartz glass ring and the longitudinal axis 6 of the sheath-material cylinder 2 run coaxially.

The hollow cylinder 6 has an outer diameter which corresponds to that of the quartz glass ring 8 and an inner diameter which is smaller by a length L1b than the quartz glass ring 8. It is placed onto the joining materials—the sheath-material cylinder 2 and the quartz glass ring 8—such that the longitudinal axes 3 and 6a run coaxially with one another, and is welded to the quartz glass ring 8 and the upper end face of the sheath-material cylinder 2. The resulting welding contact surface S is composed of an outer ring with the width L1a and an inner ring with the width L1b.

Here, L1a denotes the ring width of the welded connection between the hollow cylinder 6 and the quartz glass ring 8, and L1b denotes the ring width of the welded connection between the hollow cylinder 6 and the sheath-material cylinder 2. Summing the lengths L1a and L1b gives the total proportion L1 of the welding contact surface S with a horizontal orientation, totaling 100%, wherein the welding contact surface S extends over the entire wall width of the hollow cylinder 6.

This embodiment has the advantage that mechanical processing steps for fabricating steps, bevels, and the like are not required, neither on the hollow cylinder 6 nor on the sheath-material cylinder 2.

Alternatively and equally preferably, the quartz glass ring 8 can also first be welded to the lower end face of the hollow cylinder 6, before these joined materials are then welded to the cylinder lateral area 2c and the upper end face of the sheath-material cylinder 6.

In contrast to FIG. 5, the circumferential quartz glass ring 9 has, in the embodiment of the preform 61 in FIG. 6, a cross-section that substantially corresponds to a right-angled isosceles triangle. It is first welded with its inner lateral area 9c to the cylinder lateral area 2c of the sheath-material cylinder 2 such that the central axis of the quartz glass ring 9 and the longitudinal axis 6 of the sheath-material cylinder 2 run coaxially.

The hollow cylinder 6 has an outer diameter which corresponds to that of the quartz glass ring 9 and an inner diameter which is smaller by a length L1b than the quartz glass ring 9. It is placed onto the joined materials made of the sheath-material cylinder 2 and the quartz glass ring 9, such that the corresponding longitudinal axes 3 and 6a run coaxially with one another and are welded to the quartz glass ring 9 and the upper end face of the sheath-material cylinder 2. The resulting welding contact surface S is composed of an outer ring with the width L1a and an inner ring with the width L1b. Here, L1a denotes the ring width of the welded connection between the hollow cylinder 6 and the quartz glass ring 9, and L1b denotes the ring width of the welded connection between the hollow cylinder 6 and the sheath-material cylinder 2. The sum of the lengths L1a and L1b results in the total proportion L1 of the welding contact surface S with a horizontal orientation, which is 100%. Here too, the welding contact surface S extends over the entire wall width of the hollow cylinder 6.

This embodiment also has the advantage that mechanical processing steps for fabricating steps, bevels, and the like are not required, neither on the hollow cylinder 6 nor on the sheath-material cylinder 2.

In the embodiment of the preform 71 shown in FIG. 7, the sheath-material cylinder 2 has a conically upwardly widening upper end 10. Otherwise, it is cylindrical. The widened upper end 10 is produced, for example, during the circular grinding of the cylinder lateral area 2 in order to adjust the nominal outer diameter, by removing either no, or a small amount of, glass material there. The hollow cylinder 6 is welded to the upper, thickened end of the sheath-material cylinder such that the corresponding longitudinal axes 3 and 6a run coaxially. Here too, the welding contact surface S extends exclusively horizontally and over the entire wall width of the hollow cylinder 6.

In the embodiment of the preform 81 according to the invention shown in FIG. 8, an adapter part serves to expand the upper end 2a of the sheath-material cylinder 2. The adapter part is in the form of a conical disk 11 (more precisely: in the form of a truncated cone) made of undoped quartz glass with a thickness of 15 mm. Its minimum diameter corresponds to the outer diameter of the sheath-material cylinder 2, and its maximum diameter corresponds to the outer diameter of the hollow cylinder 6. The conical disk 11 is welded over the entire surface to the upper end face of the sheath-material cylinder 2. It therefore covers the entire circumference 4c of the hole region. The through-bores 4a; 4b for receiving the core rods 5 are therefore produced only subsequently—i.e., after the welding of the sheath-material cylinder 2 and the conical disk 11—wherein the conical disk 11 together with the sheath-material cylinder 2 is provided with drilled passages.

The hollow cylinder is then welded onto the planar upper side of the conical disk 11 such that the longitudinal axes 3; 6a run coaxially. Since the conical disk 11 and the hollow cylinder 6 have a maximum diameter which is greater than the outer diameter of the sheath-material cylinder 2, it increases the contacting surface available for the welded connection with the hollow cylinder 6. The welding contact surface S is generated solely by the direct connection between the hollow cylinder 6 and the conical disk 11—i.e., without direct contact of the hollow cylinder 6 with the sheath-material cylinder 2. It extends exclusively horizontally and over the entire wall width of the hollow cylinder 6.

In contrast to the embodiment shown in FIGS. 1 and 2, in the embodiment of the preform 12 in FIG. 9, the minimum inner diameter of the hollow cylinder 6 is 164 mm (and not 180 mm), and is thus smaller than the circumference 4c of the hole region with a diameter of 170 mm.

Accordingly, the hollow cylinder 6, in a projection onto the base body cross-section—partially covers the through-bores 4a remote from the longitudinal axis 6a. Nevertheless, fitting the sheath-material cylinder 2 with the core rods 5 from above through the inner bore of the pre-welded hollow cylinder 2 is possible, because the core rods 5 have an outer diameter which is smaller than the cross-section of the region not covered by the hollow cylinder 2. In the embodiment, the core rod diameter is 28 mm; the diameter of the partially covered through-holes is 33 mm. Of this, 3 mm are covered by the hollow cylinder 2, so that the exposed cross-section that is not covered has a minimum dimension of 30 mm.

FIGS. 1 to 9 schematically show the preforms which are fitted with the core rods (or the component ensemble made of the sheath-material cylinder and core rods). The figures also schematically show the semifinished products (shell material cylinder and holder) used for fabricating the corresponding preforms before the core rods 5 are inserted into the through-holes 4a; 4b. The above explanations regarding the exemplary embodiments for the (primary) preform and their connection to the holder, including the table data, also apply to the corresponding semifinished product for fabricating the component ensemble or the primary preform. The component ensemble and/or the preform are each obtained from the semifinished product by inserting the core rods 5 into the through-bores 4a; 4b—preferably from above—from which a secondary preform or directly the multicore fiber can be elongated.

1. A method for fabricating a multicore fiber, comprising the following method steps:
(a) providing an elongate base body containing a glass cladding material and having a first end, a second end, a base body longitudinal axis, a base body lateral area, a radial base body cross-section, a base body outer diameter and at least two through-holes which extend through the base body along the base body longitudinal axis;
(b) inserting a core rod containing a glass core material into the at least two through-holes, thereby forming a component ensemble; and,
(c) drawing the component ensemble to form the multicore fiber or processing the component ensemble further to form a preform from which the multicore fiber is drawn, the component ensemble being held by means of a holder made of glass which is connected to the base body in the region of the first end to form a welding contact surface,
wherein a holder having an elongate hollow part is used, which holder has a hollow channel with an inner contour which is larger than a circumference of the hole region within which the through-holes lie completely or with at least 90% of their hole diameter, and which has a radial outer dimension which is greater than the base body outer diameter.

2. The method according to claim 1, wherein at least a portion of the welding contact surface, preferably the entire welding contact surface, is produced before the core rods are inserted.

3. The method according to claim 1, wherein at least a portion of the welding contact surface is generated on the base body lateral area.

4. The method according to claim 3, wherein the welding contact surface extends on the base body lateral area along an extension length in the direction of the base body longitudinal axis, the extension length being in the range of 5 mm to 100 mm, and preferably at least 10 mm, and particularly preferably at least 20 mm.

5. The method according to claim 3, wherein the welding contact surface comprises at least one circumferential step and/or at least one circumferential bevel over the extension length.

6. The method according to claim 3, wherein the welding contact surface is generated both on the base body lateral area and on a first, upper base body end face.

7. The method according to claim 1, wherein an adapter part is used which is connected to the base body in the region of the upper end, and which has a radial outer dimension which is greater than the base body outer diameter, the adapter part being welded to the hollow cylindrical hollow part.

8. The method according to claim 7, wherein a substantially plate-like adapter part is connected to the upper end face of the base body, the plate-like adapter part at least partially covering the circumference of the hole region, and at least some of the through-holes extending through the adapter part.

9. A semifinished product for fabricating a multicore fiber, comprising:
(i) a base body containing a glass cladding material and having a first end, a second end, a base body longitudinal axis, a base body lateral area, a radial base body cross-section, and a base body outer diameter;
(ii) at least two through-holes distributed over the base body cross-section for receiving core rods which each have a hole diameter, and which extend through the base body along the base body longitudinal axis; and,
(iii) a holder made of glass, which is connected to the base body in the region of the first end to form a welding contact surface,
wherein the holder comprises an elongate hollow part which has a radial outer dimension, which is greater than the base body outer diameter, and which has an inner dimension, which is greater than a circumference of the hole region within which the through-holes lie completely or with at least 90% of their hole diameter.

10. The semifinished product according to claim 9, wherein at least a portion of the welding contact surface is formed on the base body lateral area.

11. The semifinished product according to claim 9, wherein the welding contact surface extends around the base body lateral area along an extension length in the direction of the base body longitudinal axis, the extension length being in the range of 5 mm to 100 mm, and preferably at least 10 mm, and particularly preferably at least 20 mm.

12. The semifinished product according to claim 11, wherein the welding contact surface comprises at least one circumferential step and/or at least one circumferential bevel over the extension length.

13. The semifinished product according to claim 9, wherein the welding contact surface is formed both on the base body lateral area and on a first, upper base body end face.

14. The semifinished product according to claim 9, wherein an adapter part is connected to the base body in the region of the upper base body end, and has a radial outer dimension which is greater than the base body outer diameter, the adapter part being welded to the hollow cylindrical hollow part.

15. The semifinished product according to claim 14, wherein a substantially plate-like adapter part is connected to the upper end face of the base body, the plate-like adapter part at least partially covering the circumference of the hole region, and at least a portion of the through-holes extending through the adapter part.
